(19) United States
(12) Patent Application Publication
(10) Pub. No.: US 2007/0253287 A1
(43) Pub. Date: Nov. 1, 2007

(54) Disposable unit

(76) Inventors: Lennart Myhrberg, Alvangen (SE); Alf Lofving, Torslanda (SE)

Correspondence Address: DICKSTEIN SHAPIRO LLP, 1825 EYE STREET NW, Washington, DC, 20006-5403, US

(21) Appl. No.: 11/723,135

(22) Filed: Mar. 16, 2007

(30) Foreign Application Priority Data
Apr. 5, 2006 (SE) 0600778-5

(51) Int. Cl. B01F 13/08; B65D 35/56; B01F 7/00

(52) U.S. Cl. 366/273; 366/302

(57) ABSTRACT

A disposable unit (1) for processing products (2) has a thin-walled container (3) of a soft material for holding the products and a processing unit (6) inside the container to make the products move. The container is in its lower portion (4) reinforced with a support (5) of a dimensionally stable material, which support has a smooth surface (9) and supports the container over its lower portion so as to counteract the occurrence of folds and other irregularities in the lower portion and the impairment of an even process effect. The inside (10) of the support is substantially cup-shaped without corners to give the lower portion of the container an optimal geometry and, consequently, an optimal process effect.

### FIELD OF THE INVENTION

The present invention relates to a disposable unit for processing products, especially for mixing or agitating solutions, dispersing or homogenising solutions or suspending solids in liquids, which unit comprises a thin-walled container of a soft material for holding the products, and a processing unit arranged in the container and adapted to make the products move.

### BACKGROUND ART

For processing products, for instance in the manner stated above, conventional process vessels of metal or other hard materials have been abandoned in recent years, and instead disposable units of the type described by way of introduction have become increasingly used.

There are many reasons for this change. One obvious reason is that the conventional vessels are expensive to manufacture and service, and they are also frequently difficult and complicated to handle. A further and often more important reason is that, precisely due to the costs, they must be used many times. This requires, in turn, extensive equipment in the vessels and around them for outside, and above all inside, cleaning after each use before they are allowed to be used once more. Such cleaning requires still greater resources if complete sterilisation of the vessels is necessary to prevent contamination. This is an absolute requirement in many contexts of process engineering, such as in the pharmaceutical and food industry.

Plants with conventional vessels and the necessary peripheral equipment for their operation, cleaning etc. necessarily become rather large and complex in order to be profitable. Therefore they are built to be stationary in carefully selected, strategic places.

Economic, process engineering and above all sterilisation considerations have thus directed the development towards units in the form of such thin-walled containers of soft material in the form of pouches or bags to be used only once and, after that, be discarded together with the processing unit arranged therein.

Precisely due to the fact that the containers have thin walls and, thus, more or less tend to fold or crease, they must, at least while the products are supplied and processed, be supported and held by a structural support. Such a structural support often has the form of, for instance, a frame which encloses the container and in which the container is placed and which prevents it from falling or collapsing. As a result, the processing unit inside the container should in the first place be prevented from contacting and damaging the inside of the container. Such damage may not always be discovered and may, if particles from the damaged container material come loose and are mixed with the products that are being processed, result in the condition that the products cannot be used and must be rejected.

Should the damage be so great that the container is punctured and starts to leak, dangerous and/or contaminating products may be emitted to the environment and pollute it. On the other hand, dangerous/contaminating substances from the environment may enter the container, thus making it necessary to reject or destroy the products that are being processed.

The frame is often designed similarly to the previously used cylindrical process vessels; however open upwards to allow the container to be placed therein and with a bottom to support the substantially horizontal lower portion of the container. When the soft and still empty container is placed in the frame and its lower portion abuts against the bottom of the frame to be supported by it, there occur practically always more or less large folds or other irregularities in the lower portion of the container.

Such folds etc. are often difficult to see and smooth down, and when the container is then filled with the products that are to be processed, the folds etc. will be still more difficult to remove due to the mass and, thus, the inner pressure of the products against the lower portion of the container. Such folds etc. are not allowed in the processing of the products since they disturb and obstruct the processing by the products impinging on the folds and changing direction or even getting stuck in the folds. This may also result in concentration variations in the processed products. After discharging the products and, as is usual, supplying them to a large number of small portion packs for use, some portion packs may then have too high or too low a concentration of the products. As a result, the effect of the products will in most cases not be as intended and may, if the worst comes to the worst, be harmful or even fatal.

The folds etc. may also, if they are large, risk being hit by the processing unit if it includes a rotating or oscillating mixer, so that the container will be damaged and maybe even punctured, with the ensuing risk of emission of dangerous and/or contaminating products, or vice versa penetration of dangerous and/or contaminating substances into the container.

### SUMMARY OF THE INVENTION

The main object of the invention is to provide a disposable unit which in a simple and effective way eliminates the problems and risks that have been described above.

A further object of the invention is to provide a disposable unit which also in other respects by an appropriate construction and design gives an even and optimal process effect on the products.

Yet another object of the invention is to provide a disposable unit which due to its disposable character and by not requiring expensive and complicated peripheral equipment can advantageously be used to allow fast construction of relatively small and/or mobile processing plants in places where they are most needed at the moment.

The above and related objects of the invention are achieved in its most general aspect by the container at least in its lower portion being reinforced with a support of a dimensionally stable material.

The container is preferably in the shape of a pouch or bag and has a circumferential wall, which at the bottom passes into the lower portion and at the top passes into an upper portion.

In a preferred embodiment, the support has a smooth surface and supports the container over substantially its entire lower portion so as to counteract the occurrence of folds and other irregularities in the lower portion and the impairment of an even process effect.

In another preferred embodiment, an inside of the support is suitably substantially cup-shaped without corners to give the lower portion of the container an optimal geometry and, consequently, an optimal process effect.

Preferably, the support is a separate component and connected to the lower portion of the container.

Still more preferred, the support is positively connected to the container in a transition zone between the lower portion thereof and the circumferential wall.

In an alternative preferred embodiment, the support is made integrally with the container and constitutes its lower portion.

In yet another preferred embodiment, the container is closed on all sides to form a closed vessel and has at least one upper inlet for supplying the products and at least one lower outlet for discharging the products.

In a particularly preferred embodiment of the disposable unit, the circumferential wall and the upper portion of the container are, before use of the container, storable in the lower portion with the support as transport and storage protection.

When the container is to be used, at least the circumferential wall of the container is preferably unfoldable or expandable when supplying the products.

For rapid and efficient manufacture of the disposable unit, the container and the support are suitably made of weldable plastic.

In a preferred embodiment of the processing unit inside the container, it comprises a rotatable or oscillatable mixer, in which case the processing unit is particularly preferably drivable by indirect force transmission by means of a drive unit outside the container.

Preferably the mixer is, inside the container, rotatably or oscillatably connected to a jacket plate, which is hermetically sealed against the lower portion of the container and has a connection for the drive unit on the outside of the container.

Preferably, the jacket plate is also made of weldable plastic and sealingly welded to the support and the lower portion of the container.

In a preferred embodiment, the jacket plate and thus the mixer and the drive unit are suitably offset from the lowest point of the lower portion of the container for improved process effect on the products, and the at least one lower outlet of the container is positioned at the lowest point for maximal discharge of the products.

In the preferred embodiment, the support comprises at least one opening at the lowest point for accommodating the at least one lower outlet of the container.

In a supplementary embodiment of the disposable unit, the inside of the support is substantially semispherical, the container being substantially semispherical and dimensioned to fit the shape of the inside of the support.

### BRIEF DESCRIPTION OF THE DRAWINGS

The invention will now be described in more detail with reference to the accompanying drawings, which by way of example illustrate one of a plurality of possible embodiments within the scope of the invention.

FIG. 1 is a schematic perspective view, obliquely from the side and in longitudinal section, of a currently particularly preferred embodiment of a disposable unit according to the invention as it appears when in use,

FIG. 2 is a view and section, corresponding to FIG. 1, of the disposable unit in the transport and/or storage state before and/or after use, and

FIG. 3 is a view and section, corresponding to FIG. 1, of the disposable unit arranged in a frame in use for processing products.

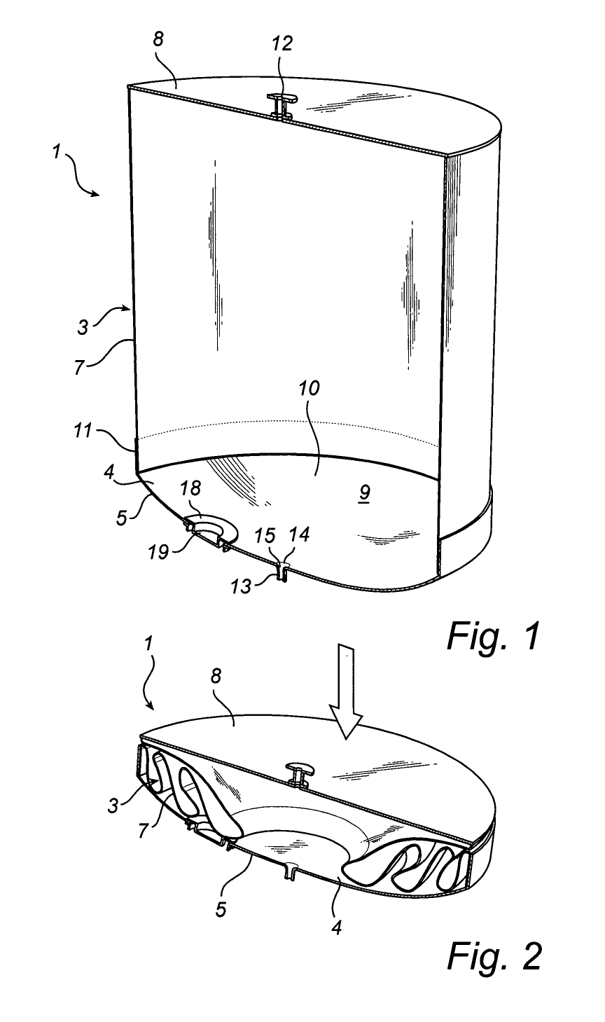

### DESCRIPTION OF A PREFERRED EMBODIMENT

The drawings illustrate a disposable unit generally designated 1 for processing products 2, especially for mixing or agitating solutions, dispersing or homogenising solutions or suspending solids in liquids. The disposable unit 1 comprises a thin-walled container 3 preferably of such a soft material as plastic for holding the products 2. In addition, the container 3 is, in its lower portion 4 as shown in the drawings, provided and reinforced with a support 5 of a dimensionally stable material, preferably thick or rigid plastic, but also sheet metal or some other rigid material can be used.

The disposable unit 1 comprises, in addition to the container 3, a processing unit 6 which is suitably arranged in the container in connection with the manufacture of the disposable unit and which will be described in more detail below, for making the products 2 move for their processing in the container.

In the preferred embodiment here illustrated, the container 3 is in use, that is filled with products 2 to be processed, substantially circular-cylindrically pouch- or bag-shaped, thus having a cylindrical circumferential wall 7 which at the bottom passes into the lower portion provided with the support 5 and at the top passes into an upper lid-shaped portion 8.

The above-mentioned support 5 has, as shown, as smooth a surface 9 as possible on its inside 10 in order to support the container 3 over substantially its entire lower portion 4 and, in this way, prevent the occurrence of folds and other irregularities in the lower portion of the container and at the same time prevent the impairment of an even process effect. As is also shown, the inside 10 of the support 5 is substantially cup-shaped without corners; thus in the first place giving the lower portion 4 of the container 3 an optimal geometry and, consequently, an optimal process effect.

For the same reasons as stated above, it may suitably also be arranged for the smooth inside 10 of the support 5, in a preferred embodiment, to be substantially semispherical and for the lower portion 4 of the container to be substantially semispherical and dimensioned to fit the shape of the inside of the support.

In the preferred embodiment, both the container 3 and the support 5 are made of weldable plastic. If the support is a separate component, which is connected to the lower portion 4 of the container 3, this connection may advantageously occur by welding. Other connecting techniques, such as gluing, are of course possible. In a special embodiment, the support 5 is then positively connected to the container 3 in a transition zone 11 between the lower portion 4 and the circumferential wall 7 thereof.

Whether the container 3 and the support 5 are made of a weldable material or not, the support is in an alternative preferred embodiment made in one piece or integrally with the container 3 to constitute its lower portion 4. In the manufacture of the container 3, the support 5 is, of course, made thicker and/or more rigid than the circumferential wall 7 and maybe also the upper portion 8 of the container 3.

Referring once more to the actual container 3, it is, as illustrated in the drawings, closed on all sides to form a closed vessel. The container 3 has in its upper portion 8 at least one inlet 12 for supplying the products 2 that are to be processed. Alternatively, the at least one inlet can be positioned in the lower portion 4 of the container 3 for supplying the products 2 from below. In one embodiment, it would even be possible to arrange one or more inlets in the circumferential wall 7 or use an optional combination/location of the such inlets.

Similarly, there is at least one outlet 13 in the lower portion 4 of the container 3 for discharging the products 2 after processing. The at least one outlet 13 is preferably arranged at the lowest point 14 of the lower portion 4 of the container 3 to allow maximum discharge of the products 2 after processing. To this end, the support 5 suitably comprises at least one opening 15 at the lowest point 14, which opening is designed and dimensioned to be able to accommodate the at least one outlet 13 of the container.

In an alternative embodiment, the lower portion 4 of the container 3 may instead have at least one common inlet and outlet for both supplying and discharging the products 2 from below.

For safe and protective transport and/or storage of the disposable unit 1 before and/or after use, the soft circumferential wall 7 of the container 3, by folding or the like, and its soft or more rigid upper portion 8 are storable in the lower portion 4, protected by the support 5. When the disposable unit 1 then is to be used and the container 3 is filled with the products 2 to be processed, the circumferential wall 7 and, thus, the entire container 3 are made to be unfolded or expanded.

Now returning to the previously briefly mentioned processing unit 6, it comprises in the preferred embodiment a rotatable or oscillatable mixer 16, the processing unit preferably being driven by indirect force transmission by means of a drive unit 17, which is arranged outside the container and suitably is releasably connectable to the mixer 16.

In the particularly preferred embodiment, the mixer 16 is inside the container 3 suitably rotatably or oscillatably connected to a jacket plate 18. This jacket plate is, by gluing, welding or the like, hermetically sealed against the support 5 and the lower portion 4 of the container 3 and has a connection 19 for the drive unit 17 on the outside of the container. It is most convenient in the context if the jacket plate 18, like the support 5 and the container 3, is made of weldable plastic to allow it to be sealingly welded to the support 5 and the lower portion 4 of the container 3.

For still better processing of the products 2, the jacket plate 18 and, thus, also the mixer 16 and the drive unit 17 are offset from the above-described lowest point 14 of the lower portion 4 of the container 3, which also means that the at least one outlet 13 may, as mentioned above, be located at the lowest point 14 to allow maximum discharge of the ready-processed products. When the products 2 in the container 3 are ready-processed, they can, as mentioned above, be discharged more or less immediately for use and/or further refining. As an alternative, the container can function excellently as a storage and/or transport vessel for the products 2 if discharge is to occur at a subsequent time. It may then in certain cases also be convenient, if the products so allow, to cool or even freeze them to be subsequently heated/thawed for discharge.

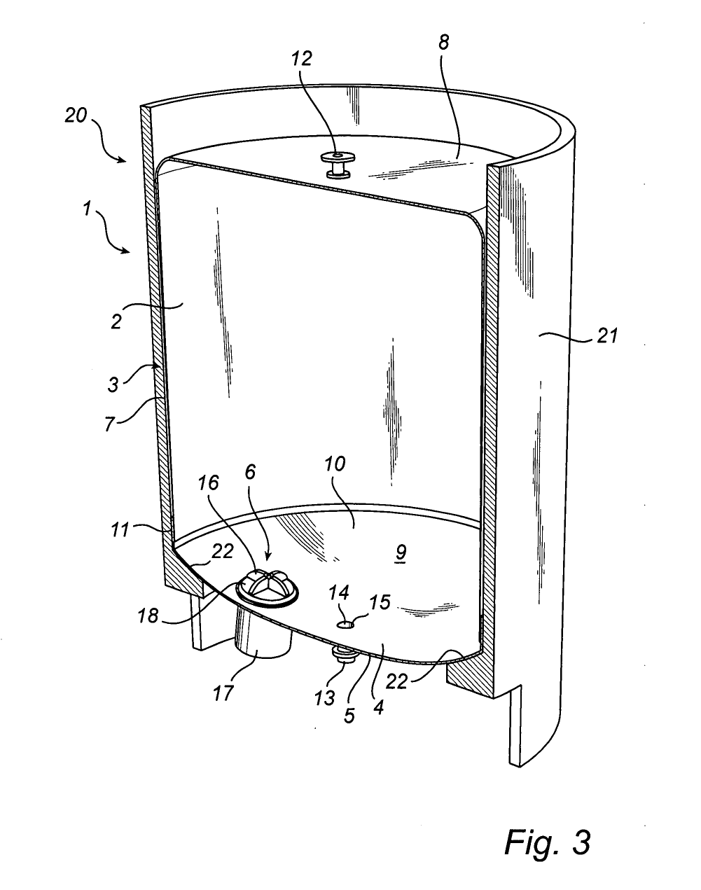

In practical use of the disposable unit 1, it is placed inside a frame 20 which is schematically shown in FIG. 3 and has an enclosing circumferential wall 21, against which rests the circumferential wall 7 of the container 3. The frame 20 is upwardly open to allow insertion of the disposable unit 1 from above instead and has at the bottom a shoulder 22 similar to an annular flange, on which rest the support 5 and thus the lower portion, completely without folds, of the container 3. The frame 20 is thus largely open also downwards to allow connection of the drive unit 17 to the processing unit 6 and of valves, tubes etc. to the inlets and outlets 12, 13 from below. In a way not shown in detail, the frame 20 can be equipped with wheels or the like to be movable with or without the disposable unit 1.

It goes without saying that the invention should not be considered limited to the particularly preferred embodiment shown and described and its variants but can be optionally modified within the scope of the appended claims.

1. A disposable unit for processing products, especially for mixing or agitating solutions, dispersing or homogenising solutions or suspending solids in liquids, which unit comprises:
a thin-walled container of a soft material for holding the products;
a processing unit arranged in the container and adapted to make the products move; and
a support of a dimensionally stable material reinforcing the container at least at the container's lower portion.

2. A disposable unit as claimed in claim 1, in which the container is in a shape of a pouch or bag and has a circumferential wall, which at a bottom passes into the lower portion and at a top passes into an upper portion.

3. A disposable unit as claimed in claim 1, in which the support has a smooth surface and supports the container over substantially the entire lower portion so as to counteract occurrence of folds and other irregularities in the lower portion and impairment of an even process effect.

4. A disposable unit as claimed in claim 1, in which an inside of the support is substantially cup-shaped without corners to give the lower portion of the container an optimal geometry and, consequently, an optimal process effect.

5. A disposable unit as claimed in claim 1, in which the support is a separate component and is connected to the lower portion of the container.

6. A disposable unit as claimed in claim 1, in which the support is positively connected to the container in a transition zone between the lower portion thereof and a circumferential wall.

7. A disposable unit as claimed in claim 1, in which the support is made integrally with the container and constitutes its lower portion.

8. A disposable unit as claimed in claim 1, in which the container is closed on all sides to form a closed vessel and in which the container has at least one upper inlet for supplying the products and at least one lower outlet for discharging the products.

9. A disposable unit as claimed in claim 1, in which a circumferential wall and an upper portion of the container are, before use of the container, storable in the lower portion, protected by the support.

10. A disposable unit as claimed in claim 8, in which at least the circumferential wall of the container is unfoldable or expandable when supplying the products.

11. A disposable unit as claimed in claim 1, in which the container and the support comprise weldable plastic.

12. A disposable unit as claimed in claim 1, in which the processing unit comprises a rotatable or oscillatable mixer and is drivable by indirect force transmission by means of a drive unit outside the container.

13. A disposable unit as claimed in claim 12, in which the mixer is, inside the container, rotatably or oscillatably connected to a jacket plate, which is hermetically sealed against the lower portion of the container and has a connection for the drive unit on the outside of the container.

14. A disposable unit as claimed in claim 13, in which the jacket plate comprises weldable plastic and is sealingly welded to the support and the lower portion of the container.

15. A disposable unit as claimed in claim 13, in which the jacket plate and the mixer and the drive unit are offset from a lowest point of the lower portion of the container for improved process effect on the products, and in which the at least one lower outlet of the container is positioned at the lowest point for maximal discharge of the products.

16. A disposable unit as claimed in claim 15, in which the support comprises at least one opening at the lowest point for accommodating the at least one lower outlet of the container.

17. A disposable unit as claimed in claim 1, in which an inside of the support is substantially semispherical and the container is substantially semispherical and dimensioned to fit a shape of the inside of the support.

18. A processing unit, comprising:
a container for holding products during processing;
an upper wall portion;
a flexible middle wall portion; and
a lower wall portion comprising a rigid support portion, wherein said flexible middle wall portion is adapted to be stored in said rigid support portion.

19. A method for using a processing unit, comprising:
providing a container for holding products during processing, the container having an upper wall portion, a flexible middle wall portion, and a lower wall portion comprising a rigid support portion, wherein said flexible middle wall portion is adapted to be stored in said rigid support portion;
storing said flexible middle wall portion in said rigid support portion when said processing unit is not in use; and
expanding said flexible middle wall portion out of said rigid support portion when aid processing unit is in use.
